(19) United States
(12) Patent Application Publication
(10) Pub. No.: US 2009/0027339 A1
(43) Pub. Date: Jan. 29, 2009

(54) Computing device pointing stick assembly

(76) Inventors: Paul j. Doczy, Cyress, TX (US); Charles A. Sellers, Houston, TX (US); Dustin L. Hoffman, Cyprass, TX (US); Walter J. Rankins, Spring, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/881,326

(22) Filed: Jul. 26, 2007

(51) Int. Cl. G06F 3/033

(52) U.S. Cl. 345/161

(57) ABSTRACT

A computing device comprising a pointing stick assembly comprising an outer portion and an inner portion, the inner portion comprising a plurality of extensions extending through the outer portion.

### BACKGROUND

Computing devices, such as laptop or notebook computers, comprise pointing sticks to direct movement of a displayed element such as a cursor on a display screen. Such pointing sticks comprise covers formed from a soft, stretchable and/or deformable material in order to conform to a user's finger and provide tactile feedback. However, such stretching and/or deforming of the covers reduces the accuracy/responsiveness of the pointing device due to excessive relative movement between the cover and the pointing stick. Furthermore, because such soft covers are easily stretched and/or deformed, the covers oftentimes detach from the pointing stick.

### BRIEF DESCRIPTION OF THE DRAWINGS

FIG. 1 is a diagram illustrating a computing device in which an embodiment of a pointing stick assembly is employed to advantage; and

FIG. 2 is diagram of a section view of the pointing stick assembly of FIG. 1 taken along the line 2-2 of FIG. 1.

### DETAILED DESCRIPTION OF THE DRAWINGS

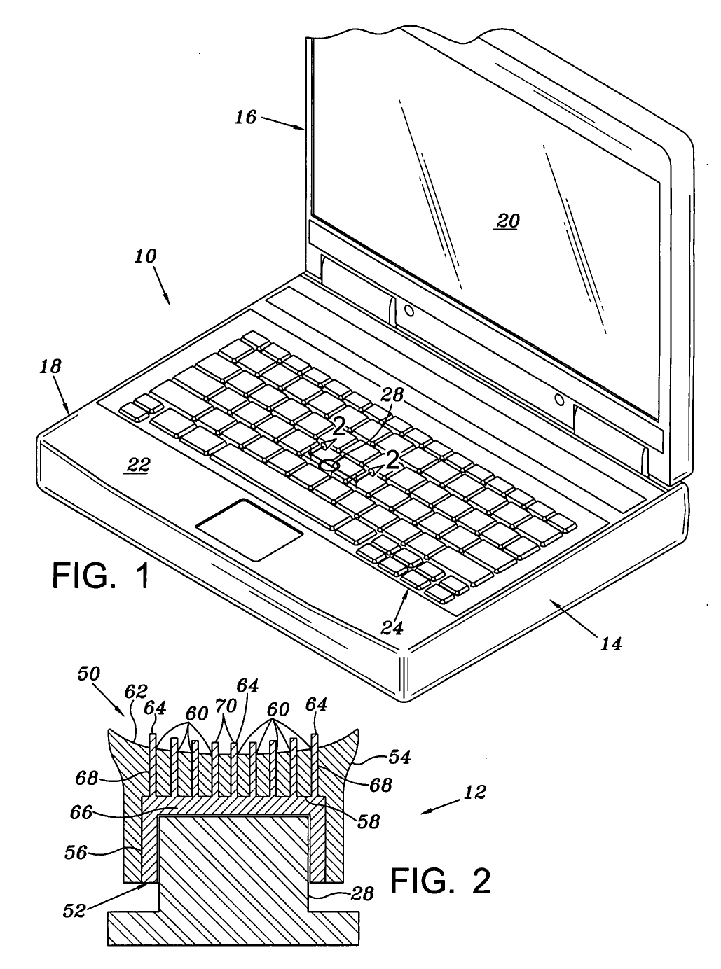

Various embodiments and the advantages thereof are best understood by referring to FIGS. 1 and 2, like numerals being used for like and corresponding parts of the various drawings

FIG. 1 is a diagram illustrating a computing device 10 in which an embodiment of a pointing stick assembly 12 is employed to advantage. In the embodiment illustrated in FIG. 1, computing device 10 comprises a laptop or notebook computer 14; however, it should be understood that computing device 10 may comprise any type of computing device such as, but not limited to, a tablet personal computer, a personal digital assistant, a gaming device, a desktop computer or any other type of portable or non-portable computing device. In the embodiment illustrated in FIG. 1, computing device 10 comprises a display member 16 rotatably coupled to a base member 18. Display member 16 comprises a display screen 20, and base member 18 comprises a working surface 22 having a keyboard 24 and pointing stick assembly 12. In operation, pointing stick assembly 12 is operable to direct movement of a displayed element, such as a cursor on display screen 20, to facilitate the use of computing device 10. In FIG. 1, pointing stick assembly 12 comprises a round or circular configuration. However, it should be understood that pointing stick assembly 12 may be configured having square, rectangular, elliptical, or another type of geometric configuration.

FIG. 2 is diagram of a section view of pointing stick assembly 12 of FIG. 1 taken along the line 2-2 of FIG. 1. In the embodiment illustrated in FIG. 2, pointing stick assembly 12 comprises a cover assembly 26 having a closed end 50 and an open end 52. In operation, open end 52 of cover assembly 26 is attached and/or otherwise coupled to a movable and/or pivotable pointing stick 28 such that closed end 50 is positioned to receive a user's finger to enable the user to direct movement of pointing stick 28. In the embodiment illustrated in FIG. 2, cover assembly 26 comprises an outer portion 54 having a top surface 62 and an inner portion 56. In some embodiments, outer portion 54 and inner portion 56 are formed from an elastomer material such as, but not limited to, a thermoplastic elastomer, thermosplastic urethane, thermoplastic rubber or any other material having a desired durometer value (hardness). In some embodiments, outer portion 54 has a durometer value greater than the durometer value of inner portion 56 such that outer portion 54 is generally stiffer and less susceptible to stretching and/or deformation than inner portion 56. According to some embodiments, the durometer value of inner portion 56 is approximately 45 and the value of outer portion 54 is approximately 75; however, it should be understood that the durometer values may be otherwise selected, such as for example, within a range between 30 and 60 for inner portion 56 and within a range between 60 and 90 for outer portion 54. It should be understood that the materials used to form pointing stick assembly 12 may be otherwise varied. In some embodiments, cover assembly 26 is manufactured using a double shot injection molding process to enable outer portion 54 to be overmolded onto inner portion 56. For example, in FIG. 2, outer portion 54 comprises a recess 58 sized to receive at least a portion of inner portion 56 such that outer portion 54 is disposed over and/or otherwise covers at least the portion of inner portion 56 near closed end 50.

In the embodiment illustrated in FIG. 2, outer portion 54 comprises a plurality of spaced apart slots 60 to receive at least a portion of inner portion 56 therethrough. For example, in FIG. 2, slots 60 extend between recess 58 and top surface 62 to receive therethrough a plurality of spaced apart extensions 64 of inner portion 56. In the embodiment illustrated in FIG. 2, extensions 64 extend through slots 60 and above top surface 62 to form a grip 72. According to some embodiments, extensions 64 comprise variable lengths forming a concave grip 72. For example, in the embodiment illustrated in FIG. 2, extensions 64 located at a peripheral/outer region 68 are longer and/or extend a further distance above top surface 62 than inner extensions 70 so that grip 72 is concave to conform to a user's finger. However, it should be understood that the shape of grip 72 may be otherwise configured.

In the embodiment illustrated in FIG. 2, inner portion 56 comprises a base 66 configured to frictionally engage pointing stick 28 to securely fasten cover assembly 26 to pointing stick 28; however, it should be understood that base 66 may be otherwise coupled to pointing stick 28 (e.g., via an adhesive or otherwise). In the embodiment illustrated in FIG. 2, extensions 64 are supported by and extend from base 66 through slots 60. However, it should be understood that inner portion 56 may be formed such that inner portion 56 is comprised solely of extensions 64 disposed within and extending outwardly from slots 60 such that recess 58 of outer portion 54 frictionally and/or otherwise engages pointing stick 28. In the embodiment illustrated in FIG. 2, cover assembly 26 comprises a gradually increasing diameter such that closed end 50 comprises a larger cross-sectional area than open end 52 to provide a larger top surface 62 and thus a larger grip 72. However, it should be understood that cover assembly 26 may be otherwise configured (e.g., a constant sized cross-sectional area or open end 52 having a larger cross-sectional area than closed end 50).

In some embodiments, outer portion 54 comprises an elastomeric material having a high durometer value to decrease the likelihood and/or amount of deflection of cover assembly 26 relative to pointing stick 28. Accordingly, embodiments of pointing stick assembly 12 enable a user to accurately control movement of pointing stick assembly 12. In addition, the increased durometer value of outer portion 54 increases the frictional engagement between cover assembly 26 and pointing stick 28 to reduce the likelihood of separation of cover assembly 26 from pointing stick 28. For example, the increased durometer value of outer portion 54 results in less deformity of inner portion 56 thereby maintaining greater frictional engagement between inner portion 56 and pointing stick 28. Furthermore, extensions 64 comprise a material having a lower durometer value than outer portion 54 to provide a flexible/soft grip 72, thereby providing tactile feedback to the user without reducing accurate controlled movement of pointing stick assembly 12 during use.

In some embodiments, pointing stick assembly 12 is manufactured having an outer portion 54 and an inner portion 56, the inner portion 56 comprising a plurality of extensions 64 extending through the outer portion 54. In some embodiments, pointing stick assembly 12 is manufactured having inner portion 56 disposed within outer portion 54. In some embodiments, pointing stick assembly 12 is manufactured having inner portion 56 coupled to a pointing stick 28. In some embodiments, pointing stick assembly 12 is manufactured such that the plurality of extensions 64 form a concave grip 72. In some embodiments, pointing stick assembly 12 is manufactured such that inner portion 56 comprises a durometer value less than a durometer value of the outer portion 54. In some embodiments, pointing stick assembly 12 is manufactured by forming outer portion 54 with a recessed area 58 to receive inner portion 56 therein. In some embodiments, pointing stick assembly 12 is manufactured by forming a plurality of slots 60 on the outer portion 54 to receive the plurality of extensions 64 therethrough. In some embodiments, pointing stick assembly 12 is formed by overmolding the outer portion 54 to the inner portion 56.

Thus, embodiments of pointing stick assembly 12 provide an outer portion 54 having a durometer value greater than the durometer value of inner portion 56 to facilitate accurate control of pointing stick assembly 12, thereby reducing and/or substantially eliminating the likelihood of cover assembly 26 detaching from pointing stick 28 during use, and also providing tactile feedback to a user of computing device 10.

What is claimed is:

1. A computing device, comprising:
a pointing stick assembly comprising an outer portion and an inner portion, the inner portion comprises a plurality of extensions extending through the outer portion.

2. The computing device of claim 1, wherein the inner portion is at least partially disposed within the outer portion.

3. The computing device of claim 1, wherein the inner portion is coupled to a pointing stick.

4. The computing device of claim 1, wherein the plurality of extensions form a concave grip.

5. The computing device of claim 1, wherein the inner portion comprises a durometer value less than a durometer value of the outer portion.

6. The computing device of claim 1, wherein the outer portion comprises a recessed area to receive the inner portion therein.

7. The computing device of claim 1, wherein the outer portion comprises a plurality of slots to receive the plurality of extensions therethrough.

8. The computing device of claim 1, wherein the outer portion is overmolded to the inner portion.

9. A method of manufacturing a computing device, comprising:
providing a pointing stick assembly having an outer portion and an inner portion, the inner portion comprising a plurality of extensions extending through the outer portion.

10. The method of claim 9, further comprising disposing the inner portion within the outer portion.

11. The method of claim 9, further comprising coupling the inner portion to a pointing stick.

12. The method of claim 9, further comprising configuring the plurality of extensions to form a concave grip.

13. The method of claim 9, further comprising providing the inner portion having a durometer value less than a durometer value of the outer portion.

14. The method of claim 9, further comprising forming the outer portion with a recessed area to receive the inner portion therein.

15. The method of claim 9, further comprising forming a plurality of slots on the outer portion to receive the plurality of extensions therethrough.

16. The method of claim 9, further comprising overmolding the outer portion to the inner portion.

17. A computing device, comprising:
a pointing stick assembly having an inner portion and an outer portion, the inner portion having a durometer value less than a durometer value of the outer portion.

18. The computing device of claim 17, wherein the inner portion comprises a plurality of extensions extending through the outer portion.

19. The computing device of claim 17, wherein the inner portion is disposed of least partially within the outer portion.

20. The computing device of claim 17, wherein the inner portion is coupled to a pointing stick.
